(19) United States
(12) Patent Application Publication
(10) Pub. No.: US 2003/0085927 A1
(43) Pub. Date: May 8, 2003

(54) Method and apparatus for single selection evaluations in interactive systems

(75) Inventor: Michael J. Muller, Medford, MA (US)

Correspondence Address: KUDIRKA & JOBSE, LLP, ONE STATE STREET, SUITE 1510, BOSTON, MA, 02109, US

(73) Assignee: INTERNATIONAL BUSINESS MACHINES CORPORATION, New York, NY (US)

(21) Appl. No.: 09/992,236

(22) Filed: Nov. 6, 2001

(51) Int. Cl. G09G 5/00

(52) U.S. Cl. 345/810; 345/835

(57) ABSTRACT

A component of a graphic user interface in an application, browser or web page includes a displayed command option and one or more evaluation icons useful in rating the immediate content or process. By selecting one of the evaluation icons, the user both initiates execution of the displayed command option and recordation of an evaluation rating associated with the selected evaluation icon. In one embodiment, the user can optionally select just the command without providing evaluation feedback. In other embodiments, the user must provide evaluation feedback in order to execute the displayed command option. Any number of evaluation feedback options may be associated with a command option, including a two dimensional array of evaluation icons, to enable the user to specify with a single selection both evaluation feedback on two parameters and execution of the displayed command option.

### FIELD OF THE INVENTION

This invention relates, generally, to data processing systems and, more specifically, to a technique for collecting evaluation feedback during the process of navigating through content or computer applications.

### BACKGROUND OF THE INVENTION

Users of computer systems often complain about having to take too many steps to execute what is, to them, a single action and often want to execute the minimum number of actions in order to accomplish their tasks. The ability of providers to accommodate this user need has become a commercial differentiator—see, for example, single-click shopping disclosed in U.S. Pat. No. 5,960,411. It is thus advantageous for providers, such as on-line vendors and service providers, to offer a streamlined method for conducting business or other user activities. It is also advantageous to provide streamlined user interface methods for conducting business since users are more likely to complete purchases or other activities, and are more likely to return to the provider's website.

Providers, however, need to obtain evaluation feedback from users on materials or experiences on the provider's system, site, or service. For example, in the field of customer satisfaction, if customers refer to an automated service, such as a website, for answers to routine questions, the provider of the service, e.g. the website owner, may wish to know if each customer was able to find the information that s/he wanted. Customers are typically trying to solve a problem, and are unwilling to spend extra time answering automated/on-line questions regarding quality of service.

In many knowledge management (KM) settings, a company will make a large number of knowledge objects, typically text files, available to internal staff who must sort through those objects to find information helpful to solve a particular business problem. Common advice in KM is to find a way of “grading” the usefulness of the knowledge objects, so that the more useful objects can be made easily available, and the less useful objects can be replaced or retired. Unfortunately, many users of the knowledge objects refuse to spend extra time to evaluate them.

In on-line Communities, a commonly requested feature is for a recommendation service—e.g., in an on-line community of winter-sports enthusiasts, such a service might state, “Sixteen skiers rated these instructions as useful to them.” Unfortunately, it is difficult to persuade users to take extra time (i.e., to engage in extended dialogues with the system) to do this kind of recommending.

When providers are developing new services and are offering them on an evaluation basis, e.g. “try this and tell us if you like it”, they are often very interested in obtaining feedback from users. However, users are not necessarily coming to the under-development services with the purpose of evaluating them, and may be unwilling to take extra time to provide evaluation feedback.

Unfortunately, the need for a simple, streamlined user experience often conflicts with the service providers desire to obtain meaningful evaluation of various aspects of its products and services. Accordingly a need exists for a technique for obtaining user feedback with minimum user effort.

### SUMMARY OF THE INVENTION

The present invention discloses a technique, which takes advantage of the fact that a user typically must perform an action to conclude a sequence of activities. The technique combines the action that is anticipated by the user and the action of providing feedback to the provider into a single operation. An evaluation-feedback response embedded within a response to a users' default activities provides a mechanism for obtaining evaluation feedback with minimum user effort. The action may be as simple as selecting a “Close” or “Done” command or somewhat more complex, such as selecting a “Continue to next page” or “Go to Step Two” command on a graphic user interface.

According to the invention, a component of a graphic user interface in an application, browser or web page includes a displayed command option and one or more evaluation options useful in rating the immediate content or process. In one embodiment, these evaluation options could be displayed as evaluation icons. By selecting one of the evaluation icons, the user both initiates execution of the displayed command option and recordation of a rating or evaluation feedback associated with the selected evaluation icon. In one embodiment, the user can optionally select just the command without providing evaluation feedback. In other embodiments, the user must provide evaluation feedback in order to execute the displayed command option. Any number of evaluation feedback options may be associated with a command option, including a two dimensional array of evaluation icons which enable the user to specify with single selection evaluation feedback on two parameters and execution of the displayed command option.

According to a first aspect of the invention, in a computer system having a display and capable of generating a user interface through which a user may interact with the system, a method for collecting user evaluation feedback comprises: (A) displaying on the graphic user interface an evaluation component comprising at least one displayed command option and at least one evaluation feedback option; (B) receiving user selection criteria for one of the command option and the evaluation feedback option; and (C) initiating execution of a command associated with the displayed command option. In one embodiment the method further comprises: (D) recording user selection of the at least one evaluation feedback option. In an alternative embodiment of the method a plurality of evaluation feedback option are included in the evaluation component.

According to a second aspect of the invention, a computer program product and data signal for use with a computer system having a display and capable of generating a user interface through which a user may interact with the system, comprise: (A) program code for displaying on the graphic user interface an evaluation component comprising at least one displayed command option and a plurality of evaluation feedback options; (B) program code for receiving user selection criteria for one of the command option and evaluation feedback options; and (C) program code for initiating execution of a command associated with the displayed command option.

According to a third aspect of the invention, an apparatus for use with a computer system having a display and capable of generating a user interface through which a user may interact with the system, the apparatus comprises: (A) program logic for displaying on the graphic user interface an evaluation component comprising at least one displayed command option and a plurality of evaluation feedback options; (B) program logic for receiving user selection criteria for one of the command option and evaluation feedback options; and (C) program logic for initiating execution of a command associated with the displayed command option.

### BRIEF DESCRIPTION OF THE DRAWINGS

The above and further advantages of the invention may be better understood by referring to the following description in conjunction with the accompanying drawings in which:

FIG. 1 illustrates conceptually a block diagram of a computer systems suitable for use with the present invention;

FIG. 2 illustrates conceptually the relationship between the components of the system in which the present invention may be utilized;

FIG. 3 illustrates conceptually a computer network environment in which the present invention may be utilized;

FIG. 4A illustrates conceptually graphic user interfaces (GUI) in accordance with one embodiment of the present invention;

FIG. 4B is a flow chart which illustrates the process steps performed during selection of the graphic user interfaces of FIG. 4A;

FIG. 5A illustrates conceptually graphic user interfaces (GUI) in accordance with another embodiment of the present invention;

FIG. 5B is a flow chart which illustrates the process steps performed during selection of the graphic user interfaces of FIG. 5A;

FIG. 6A-D illustrate conceptually graphic user interfaces (GUI) in accordance with other embodiments of the present invention;

FIG. 7A-E illustrate conceptually graphic user interfaces (GUI) in accordance with other embodiments of the present invention;

FIG. 8A-E illustrate conceptually graphic user interfaces (GUI) in accordance with other embodiments of the present invention;

FIG. 9 illustrate conceptually graphic user interfaces (GUI) in accordance with another embodiment of the present invention;

FIGS. 10A-B illustrate conceptually graphic user interfaces (GUI) in accordance with another embodiment of the present invention; and

FIG. 11 is a flow chart which illustrates the process steps performed during performed during the present invention.

### DETAILED DESCRIPTION

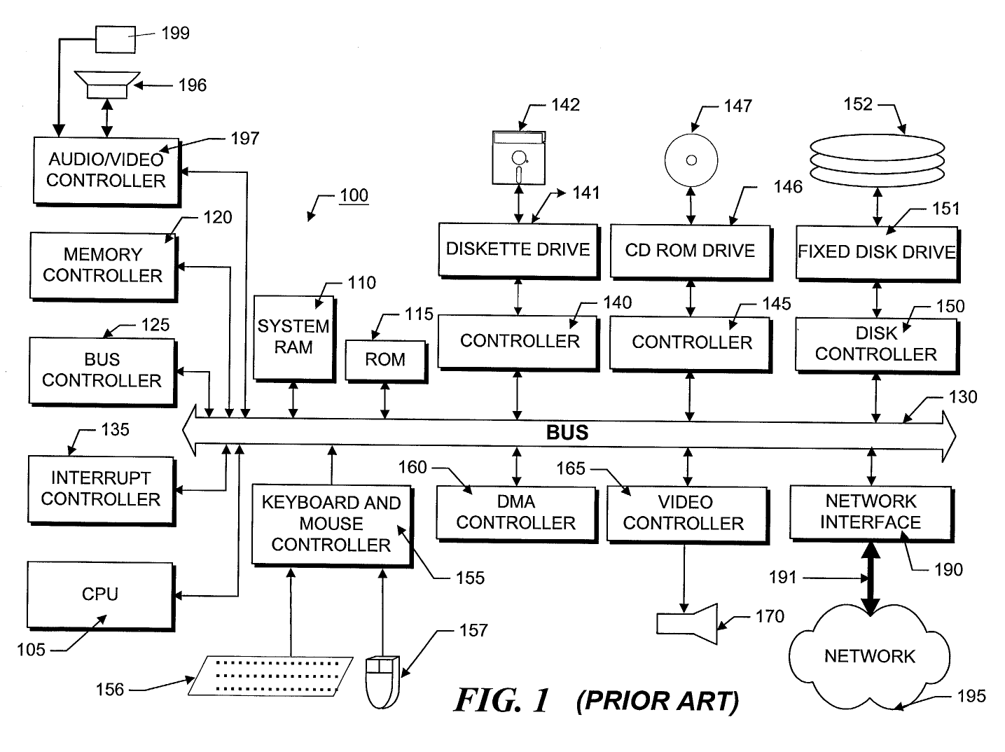

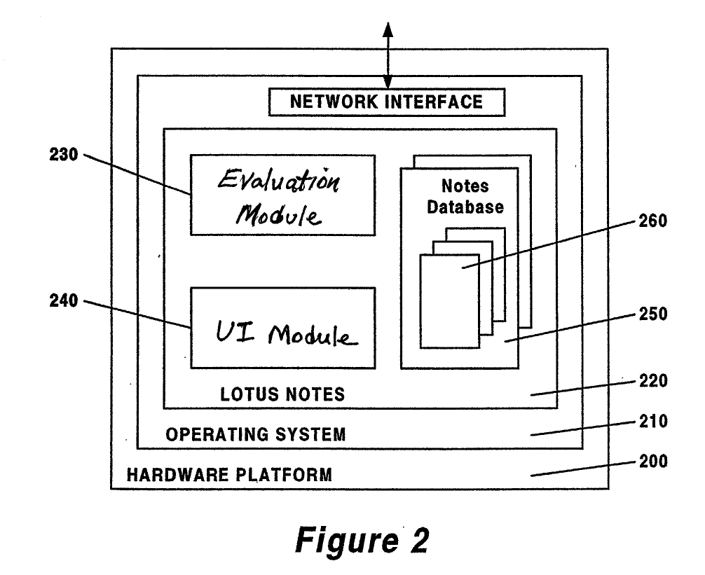

FIG. 1 illustrates the system architecture for a computer system 100, such as an IBM PS/2® computer on which the invention can be implemented. The exemplary computer system of FIG. 1 is for descriptive purposes only. Although the description below may refer to terms commonly used in describing particular computer systems, such as an IBM PS/2 computer, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system. Computer system 100 also includes a communications adapter 190 which allows the system to be interconnected to a local area network (LAN) or a wide area network (WAN), schematically illustrated by bus 191 and network 195.

Computer system 100 is generally controlled and coordinated by operating system software, such the OS/2® operating system, available from International Business Machines Corporation, Armonk, N.Y., or Windows ® operating system, available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including AIX, UNIX and LINUX, DOS, etc. One or more applications 220 such as Lotus Notes or Lotus Sametime, both commercially available from Lotus Development Corp., Cambridge, Mass. may execute under control of the operating system. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the C++ language or as well as other object-oriented standards, including the COM specification and OLE 2.0 specification for MicroSoft Corporation, Redmond, Wash., or, the Java programming environment from Sun Microsystems, Redwood, Calif.

In the illustrative embodiment, the elements of the system are so implemented in the C++ programming language using object-oriented programming techniques. C++ is a compiled language, that is, programs are written in a human-readable script and this script is then provided to another program called a compiler which generates a machine-readable numeric code that can be loaded into, and directly executed by, a computer. As described below, the C++ language has certain characteristics which allow a software developer to easily use programs written by others while still providing a great deal of control over the reuse of programs to prevent their destruction or improper use. The C++ language is well known and many articles and texts are available which describe the language in detail. In addition, C++ compilers are commercially available from several vendors including Borland International, Inc. and Microsoft Corporation. Accordingly, for reasons of clarity, the details of the C++ language and the operation of the C++ compiler will not be discussed further in detail herein.

Network Environment

The illustrative embodiment of the invention may be implemented as part of Lotus Notes®, commercially available from Lotus Development corporation, Cambridge Massachusetts, a subsidiary of International Business Machines Corporation, Armonk, N.Y., however it will be understood by those reasonably skilled in the arts that the inventive functionality may be integrated into other applications as well as the computer operating system.

The Notes architecture is built on the premise of databases and replication thereof. A Notes database, referred to hereafter as simply a “database”, acts as a container in which data Notes and design Notes may be grouped. Data Notes typically comprises user defined documents and data. Design Notes typically comprise application elements such as code or logic that make applications function. In Notes, every database has a master copy which typically resides on the server or user platform where the database was created. All other copies of the database are replicas of the master copy. Replicas of databases may be located remotely over a wide area network, which may include as a portion thereof one or more local area networks. In the illustrative every object within a Notes database, is identifiable with a unique identifier, referred to hereinafter as “Note ID”, as explained hereinafter in greater detail.

The Notes environment is loosely coupled environment. A loosely coupled network environment is one in which users may log on or off the network at will. “Locking” of a document is necessary to prevent simultaneous modification of a document by multiple Notes users. A document as used herein may refer to a document, database, code, a “Note” or any file which is accessible and storable by a computer system. The Notes Storage Facility (NSF) architecture defines the manner in which documents and databases are created, modified and replicated among Notes servers across a computer network. Information regarding the Notes Storage Facility and its specification is available from Lotus Development Corporation as well as on-line at www.Notes.net.

To implement the primary functionality of the present invention in a Lotus Notes environment, two routines or modules, referred to hereafter as evaluation module 230 and UI module 240 are implemented within the Lotus Notes application and interact with the existing functionality, routines or commands of Lotus Notes, many of which are publicly available. A Lotus Notes client application, referred to hereafter as application 220 executes under the control of operating system 210 which in turn executes within the hardware parameters of hardware platform 200, which may be similar to that described with reference to FIG. 1. Evaluation module 230 interacts with application 220 and within one or more document 250 in databases 260. The functionality of evaluation module 230 and its interaction with application 220 and within one or more databases 260 is described hereafter.

In the illustrative embodiment, evaluation module 230 and UI module 240 may be implemented in an object-oriented programming language such as C++. Accordingly, the data structures used to the graphic user interface(s), hereafter referred to as an “evaluation component”, and other objects displayable by application 220 may be objects or groups of objects. In light of the description herein, the construction and So function of modules 230 and 240 are within the scope of understanding of those reasonably skilled in the arts and will not be detailed here for brevity.

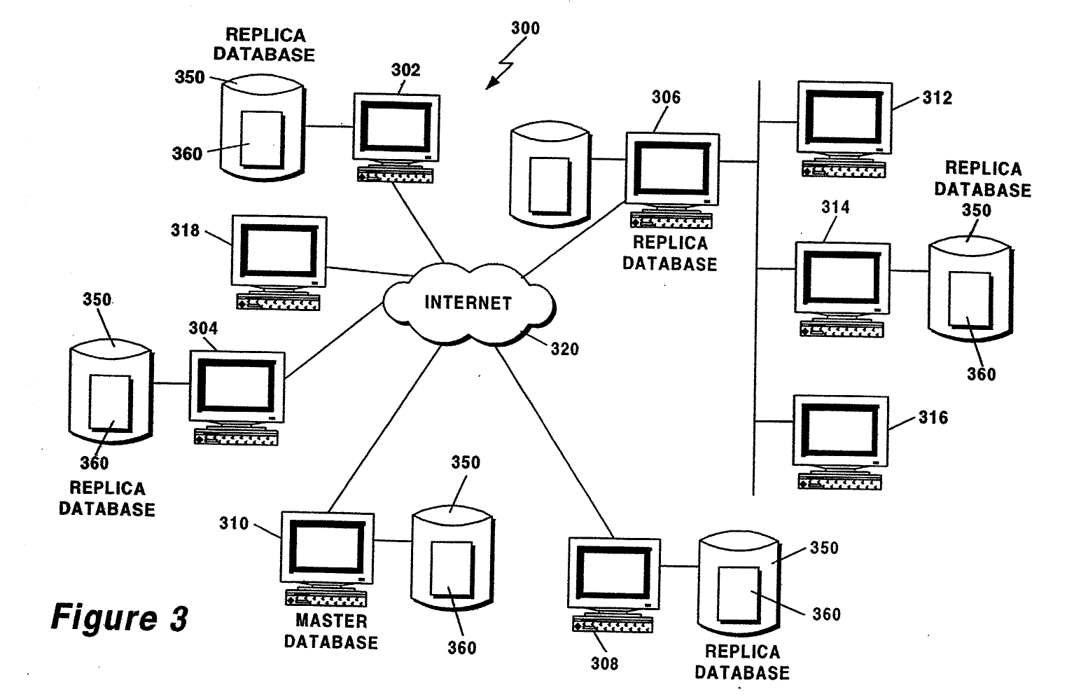

FIG. 3 illustrates a network environment in which the invention may be practiced, such environment being for exemplary purposes only and not to be considered limiting. Specifically, a packet-switched data network 300 comprises a servers 302-310, a plurality of Notes processes 310-316 and a global network topology 320, illustrated conceptually as a cloud. One or more of the elements coupled to global network topology 320 may be connected directly or through Internet service providers, such as America On Line, Microsoft Network, CompuServe, etc. As illustrated, one or more Notes process platforms may be located on a Local Area Network coupled to the Wide Area Network through one of the servers.

Servers 302-308 may be implemented as part of an all software application which executes on a computer architecture similar to that described with reference to FIG. 1. Any of the servers may interface with global network 320 over a dedicated connection, such as a T1, T2, or T3 connection. The Notes processes 312, 314, 316 and 318 may likewise be implemented as part of an all software application that run on a computer system similar to that described with reference to FIG. 1, or other architecture whether implemented as a personal computer or other data processing system. As illustrated conceptually in FIG. 3, servers 302-310 and Notes client process 314 may include in memory a copy of database 350 which contains document 360. For purposes of illustration, the copy of database 350 associated with server 310 is designated as the “master” copy of database 350. All other copies of database 350 within the network are replica copies of the master copy.

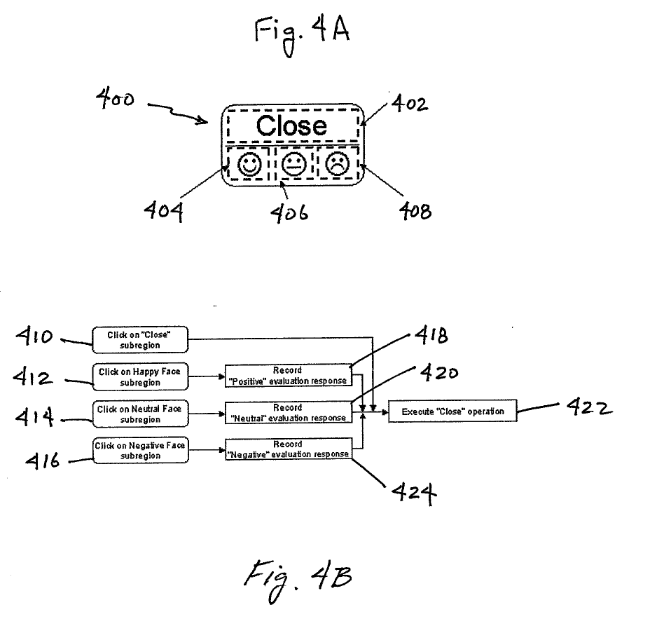

FIGS. 4A-B illustrate the graphic interface in accordance with the illustrative embodiment. In particular, FIG. 4A illustrates an evaluation component 400 in accordance with one illustrative embodiment of the invention. In the illustrative embodiment, user interface is implemented graphically in a manner be understood by those reasonably skilled in the arts. Such a graphic implementation may be part of a graphic user interface of the operating system or, as in the illustrative embodiment, part of an application. As illustrated, evaluation component 400 comprises a command menu option 402 describing at least one command executable at a point in application 220, as well as well as a plurality of evaluation icons 404, 406 and 408 which provide a user with some graphic indication of the type of feedback to be given upon selection of the icon. Generally, a evaluation component 400 may be arranged into a compact interface and may be implemented as an object which, in turn, comprises a series of other objects having data attributes representing the characteristics of the component, including its visual representation. Such objects capable of performing methods on such data members and attributes.

With the evaluation component 400 of FIG. 4A user can select the command menu option 402, typically by moving the cursor to the command menu option and selecting that option, i.e., “Close” and perform the normal Close-window operation, without providing an evaluation feedback to the provider. If the user chooses to select evaluation icon 404, e.g. the happy face icon, then the system records the positive-evaluation response as feedback to the provider and performs the normal Close-window operation. Similarly, if the user selects evaluation icon 406, e.g. the unhappy face icon, then the system records the negative-evaluation response, and performs the normal Close-window operation. Similarly, if the user selects the evaluation icon 406, e.g. the neutral face icon, then the system records the neutral-evaluation response, and performs the normal Close-window operation. Accordingly, each evaluation option, when selected, initiates recordation of the evaluation response, and execution of the function associated with the command menu option displayed within evaluation component 400. Moving the cursor to a command menu option or evaluation option and selecting that option may be done with a pointing device, e.g. single clicking a mouse button, as in the illustrative embodiment. Alternatively, one or more keys of a keyboard, such as the arrow keys and enter key on a conventional alphanumeric keyboard, may be used.

Referring to FIG. 4B, a flow chart of the possible process flows for selection of the evaluation component is illustrated. Specifically, if the command menu option 402 was selected by a user, as indicated by block 410, UI module 240 will provide the command signal directly to application 220, which, in turn, will perform the appropriate command operation, as indicated by block 422 of FIG. 4B, e.g. in this instance, a “close” operation. If, however, the user selected the evaluation icon 404, as indicated by block 412, the signal information will be passed to evaluation module 230 which will perform registration or recordation of the evaluation selection, as indicated by block 418, prior to or substantially simultaneously with or after execution of the operation, as indicated by block 422. Similarly, selection of one of evaluation icons 406 and 408, as indicated by blocks 414 and 416, respectively, will cause similar recordation of the selection criteria, as indicated by blocks 420 and 424, respectively, and execution of the command operation, as indicated by block 422.

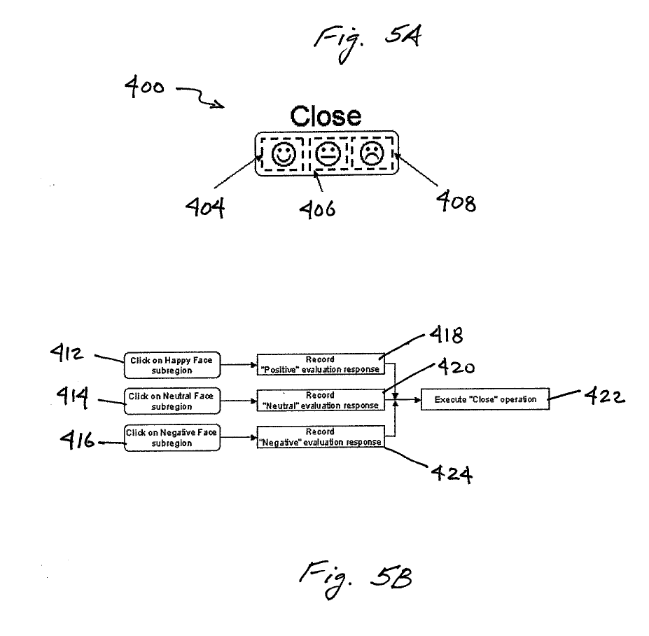

With the evaluation component 400 of FIG. 5A, user must select one of the evaluation icons 404-408 as a “forced choice” in order to invoke the command menu option displayed within evaluation component 400. Accordingly, the user is not provided with the option of performing the designated menu command without providing evaluation feedback. As with the evaluation component of FIG. 5A, any of evaluation icons 404-408, if selected, causes both recording of the evaluation response, and performance of the function associated with the command menu option displayed within evaluation component 400.

FIG. 5B illustrates the process flow associated with the evaluation component of FIG. 5A. This process flow is similar to that illustrated in FIG. 4B except that the user is not provided with an option 410 of selecting the command without providing evaluation feedback.

UI module 240 is responsible for rendering the actual evaluation component 400 and interfacing with application 220 and operating system 210 in order to render the graphic on the display of the computer system. UI module 240 includes control code and/or a series of objects which determine the command menu option rendered in the evaluation component 400 and the evaluation icons as well as their coordinate. Accordingly, upon selection of any of the other regions within evaluation component 400, UI module 240, in conjunction with operating system 210, determines which regions of the component were selected and provides the information to application 220 and evaluation module 230. UI module 240 includes a control program or series of objects which render the appropriate command menu option within the evaluation component 400 at the appropriate time during execution of the application 220; determines when a user has selected one or more of the delineated regions within the evaluation component 400; passes the appropriate signal on to application 220 for execution of the command option; and passes the appropriate signal on to evaluation module 230 when an evaluation icon is selected.

The illustrative embodiment of the present invention is shown within the context of a computer system in which both the operating system 210 and the application 220 have a GUI. For the most part, the operating system 210 controls the communications between application 220 and/or database 260 and the evaluation component 300 of the illustrative embodiment. Typically, the operating system 210 provides basic services to the application 220, such as constructing windows and controlling display and input and/or pointing devices. For example, the operating system 210 will accept signals from the mouse and use those to drive the display of the mouse cursor. When a mouse selection is made, the operating system 210 will send messages to the application 220, where the 220 interprets the messages and translates them into appropriate application activity while evaluation module 230 and UI module 240. When a pointing device is used to manipulate the evaluation component 400, operating system 210 controls communications among the pointing device, display, UI module 240, and evaluation module 230 to ensure that the proper application activity is undertaken in response to the user's selection and that the proper evaluation feedback rating is provided to application 220 or database 260, as applicable. Various implementations may also involve a certain level of direct communication between the application 220 and evaluation component 400 itself. Evaluation module 230 includes a control program or series of objects which determine from user selection criteria which evaluation option has been selected and reports records or registers which evaluation option was selected.

In the illustrative embodiment in which application 220 is a Lotus Notes client, the evaluation selection criteria may be recorded in a Notes database 260 using the format of a Lotus Notes database. This database may then be reconciled with other Notes databases within a Lotus Notes environment, as illustrated in FIG. 3, through the peer-to-peer algorithm which exists within the Notes environment.

Depending on the implementation of the invention, evaluation module 230 may likewise interface with application 220, record various user identification criteria which may be also recorded in the record associated with the application. For example, the record in which the evaluation selections are recorded may also include generic user information of a nonpersonal nature or, alternatively, may include a complete user profile including name, web address and other contact information. In this manner, the evaluation criteria may be useful in demographic profiling once properly evaluated and compiled. Such more sophisticated record keeping will be useful as well with the other embodiments disclosed hereafter.

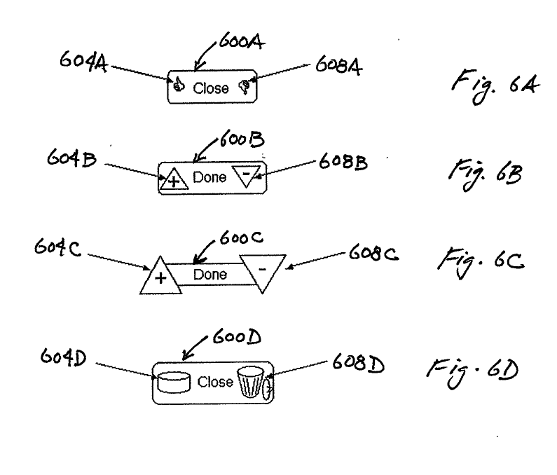

FIGS. 6A-D illustrate alternative implementations of evaluation component 600A-D in which the user must select one of the evaluation icons 604 or 608 in order to perform the command option illustrated. Specifically, in FIG. 6A the subregion labeled “close” cannot be selected. The user must select evaluation icon 604A to execute the close operation with a positive evaluation, or, select the evaluation icon 608A to execute the close operation with a negative evaluation selection. The evaluation components 600 of FIGS. 6B and 6C operate in a similar manner except that the command operation label is “done”. The evaluation components 600A-C illustrated in FIGS. 6A-C include only two evaluation icons, unlike the evaluation components 6400 of FIGS. 4A and 5A which offer a positive, neutral and negative evaluation feedback opportunity.

The evaluation icon 600D of FIG. 6D is similar to that disclosed in FIG. 6A-C in that the user must select one of the evaluation icons in order to execute the displayed command option, however, in this instance, instead of just registration of an evaluation feedback selection, selection of one of the evaluation icons 604D or 608D causes additional command operations to be executed. Specifically, selection of evaluation icon 604D will cause the close operation to be executed with the results of the prior task will be saved to a local or remote memory, as indicated by the database icon. Conversely, selection of evaluation icon 608D will cause the close operation to be executed with the results of the prior operation discarded. In this manner, selection of an evaluation icon may perform the role of both providing evaluation feedback as well as providing further instructions to application 220 and/or operating system 210.

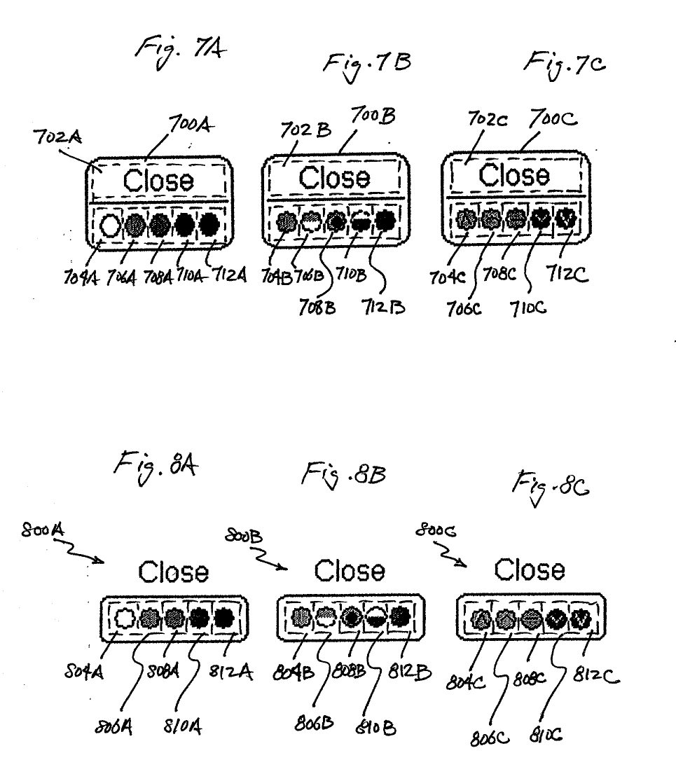

As opposed to the evaluation component 600A-D of FIGS. 6A-D in which there were only positive or negative evaluation icons, evaluation components 700A-C and 800A-C of FIGS. 7A-C and 8A-C, respectively, provide for multiple evaluation feedback options. Otherwise the construction and function of evaluation components 700A-C is similar to that of evaluation component 400 of FIG. 4A in which the user may directly select command option without providing feedback evaluation. Similarly, the construction and function of evaluation components 800A-C is similar to that of evaluation component 400 of FIG. 5A in which the user must select one of the evaluation icons in order to have the displayed command option executed. As illustrated, in FIGS. 7A-C, each evaluation component provides five evaluation icons 704-712: two positive, one neutral and two negative from which the user may select. These icons may be differentiated by color, as in FIG. 7A, a combination of color and symbols, as in FIG. 7B, or by symbols and shapes as in FIG. 7C. Evaluation components in these embodiments provide the user with a greater range of feedback selection. It will be obvious to those reasonably skilled in the art that the manner in which the feedback is registered or recorded by evaluation module 230 using these embodiments will likewise have to be more sophisticated including either more counters, one associated with each of the evaluation/selection options, or, with a more sophisticated record which allows for updating at least five fields or variables within the record. The evaluation icons illustrated in FIG. 8 are similar to those of FIG. 7 except that selection of an evaluation icon is not optional in order to have the displayed command option executed.

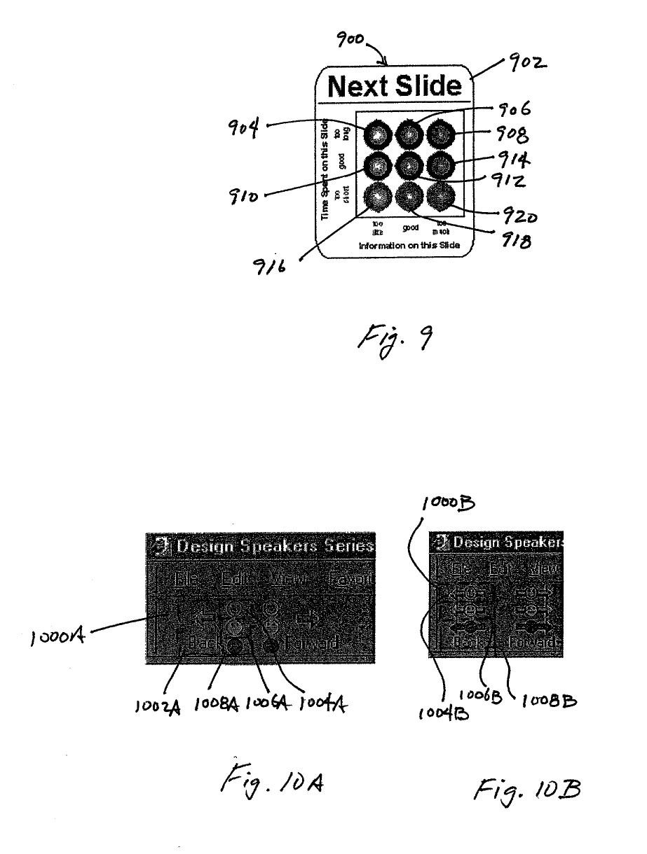

FIG. 9 illustrates yet another embodiment of an evaluation component 900 in which a plurality of evaluation icons 904-920 are arranged in a two-dimensional array along with a command option 902. As illustrated, evaluation component 900 is useful for instructional materials such as slides, web pages, or other documents containing content in which feedback is desirable. By specifying a first evaluation parameter along one axis of the array and a second evaluation parameter on a second axis of the array, a user may select a single evaluation icon to provide feedback simultaneously on the two separate parameters, as well as to initiate execution of the displayed command option 902. For example, in the evaluation component 900 illustrated, the x or horizontal axis of the array is used to evaluate the amount of information within the slide while the y or vertical axis of the array is used to evaluate the amount of time the user spent on the slide. The evaluation icon 912 serves as the neutral feedback option i.e., the information on this slide is neither too much nor too little, and the time required for this slide is neither too long nor too short. As illustrated, the individual evaluation icons 904-920 may be color coded, and/or, alternatively, provided with symbols, to assist the user in determining the degree of positive or negative evaluation provided through evaluation component 900. Otherwise the construction and function of evaluation component 900 may be similar to that of either evaluation components 400 of FIGS. 5A or 4A, in that the user may directly select command option with or with out feedback evaluation, respectively.

Applet Implementation

The embodiment of the invention illustrated above has been made with reference to a Lotus Notes application within a Lotus Notes environment. It will be obvious to those reasonably skilled in the arts that other application environments may likewise benefit from the invention as well. For example, a small application or applet written in the JAVA programming language, an environment developed by Sun Microsystems, Palo Alto, Calif., may be utilized in conjunction with one or more commercially available web browsers such as Internet Explorer, commercially available from Microsoft Corporation, Redmond, Wash., or other web browsers developed by other companies. In this manner, the applet may be responsible for execution of the command as well as registration of the evaluation feedback information, or, alternatively, may transmit a command signal to a remote server with or without the evaluation feedback as well. Still, alternatively, the JAVA applet may either execute the command locally within the applet code itself or may send the command signal to a remote server while buffering or maintaining locally the evaluation feedback data which may then be transmitted to a remote database or server at a later time.

In such an implementation, the JAVA code applet will execute locally on the computer system in conjunction with a client browser and transmit back to a remote server symbolic language which the server can use to interpret as indications of which regions within the evaluation component were selected.

Web Server Implementation

In yet another embodiment of the present invention, the evaluation component may be imbedded within a web page using HTML language. In such an embodiment, a server application is responsible for the rendering of one or more web pages. Referring again to FIG. 3, but this time assuming a client/server network environment that does not have to be a Lotus Notes environment, a server 310 performs the functions of a traditional web server enabling access to one or more web pages by other processes connected to Internet 320. In this embodiment, web server 310 contains code which performs the functions of evaluation module 230 and UI module 240.

Server 310 may be implemented using a hardware platform similar to that illustrated with reference to FIG. 1. Executing under the control of an operating system are one or more applications necessary for web server 310 to perform its appropriate functions. Specifically, web server 310 presents web pages to the network user and controls the flow of information to/from any associated databases. In the illustrative embodiment, the functions performed by web server 310 may be implemented either with object-oriented programming techniques using the appropriate class definitions and objects for values within the database, or, alternatively, using a non-object oriented language such as the C++ programming language.

Web server 310 retains in memory one or more “pages” which collectively may comprise a web site used to visually present the information on the pages. One or more of the pages accessible on web server 310 may contain address information in the form of a Hypertext Markup Language (HTML) tag which may be downloaded over the Internet 320 to a browser process executing on any of the other computer systems connected to the network. Such HTML tag may include the IP address or E-mail address associated with the web site.

Web server 310 functions to render pages to a network user connected to the web server 310 and to pass data received from a network user to database through the appropriate Application Program Interfaces (APIs). In the illustrative embodiment, the web server 310 may utilize a plurality of Visual Basic, Java script files and/or Java applets, or other programming languages to create active web pages. Web server 310 may include a database interface (not shown) which functions as the interface between web server 310 and a database server 308. Such database interface may be implemented via ODBC, Remote Procedure Call libraries or other similar technologies which enables the interface to make remotely access the database server 308 and to service calls received from database server 350.

A page may be provided with any of the evaluation components as described herein. In this embodiment, selection of the region of the web page via a web browser will cause the server application 310 to execute the appropriate command option as well as to register the evaluation feedback selection. In this embodiment, a simple method for tracking evaluation feedback data of the web page content is to have a counter assigned to each of the evaluation icons. Selection of an evaluation icon by a user of the page would cause incrementing or decrementing of the counter, depending on the implementation, by the server application. Alternatively, the server application may transfer the evaluation feedback data to a separate database if necessary for evaluation and analysis.

Browser Implementation

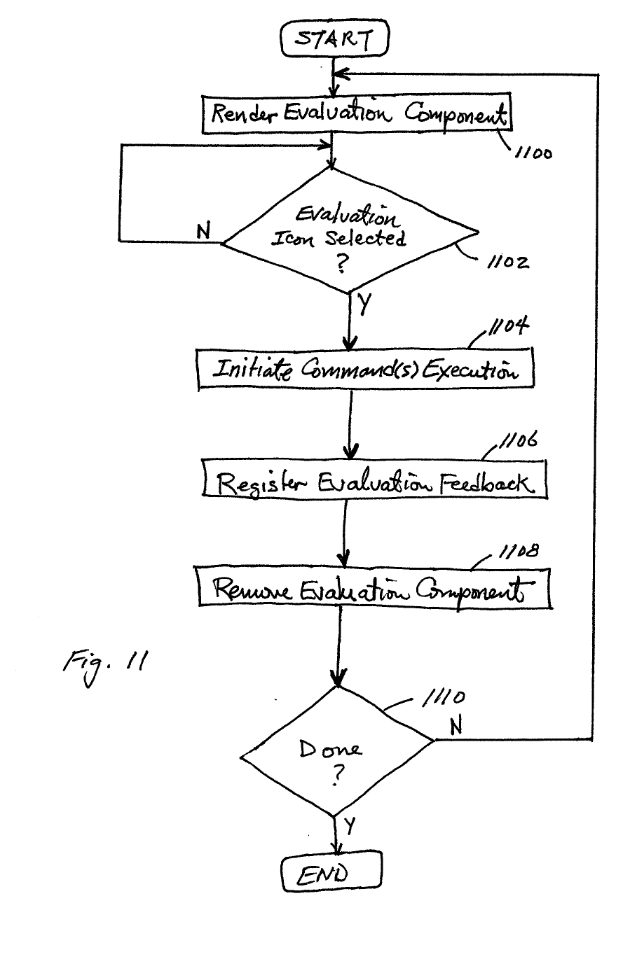

In yet another embodiment of the invention, as illustrated in FIGS. 10A-B, the evaluation components 1000A-B, respectively, may be integrated directly into the command tool bar of a web browser to form an evaluation component 1000. The construction and function of evaluation component 1000A is similar to that of evaluation component 400 of FIG. 4A in which the user may directly select command option 1002A without providing feedback evaluation through selection of one of the evaluation icons 1004A-1008A. Similarly, the construction and function of evaluation components 1000B is similar to that of evaluation component 400 of FIG. 5A in which the user must select one of the evaluation icons 1004B-1008B in order to have the displayed command option executed. In such an implementation, feedback is provided on the web page or content currently being displayed at the time the prior or the next page is accessed. In this embodiment, a modification to the standard HTTP signaling protocol between the web browser and a web server would be provided. In the normal HTTP signaling protocol, a request for another page from a browser to a server includes the name of the command process and any command arguments specifically transmitted at the time. The present invention would require, in addition, the name of a particular web page and the evaluation feedback data to be likewise be transmitted along with each new page request. In this manner, every entity publishing pages of content on a web server is able to obtain feedback about the page as a user navigates through one or more web pages with a browser having the modified command tool bar as described herein.

The embodiment of the invention illustrated above has been made with reference to a Lotus Notes application within a Lotus Notes environment. It will be obvious to those reasonably skilled in the arts that other application environments may likewise benefit from the invention as well. For example, a small application or applet written in the JAVA programming language, an environment developed by Sun Microsystems, Palo Alto, Calif., may be utilized in conjunction with one or more commercially available web browsers such as Internet Explorer, commercially available from Microsoft Corporation, Redmond, Wash. In this manner, the applet may be responsible for execution of the command as well as registration of the evaluation feedback information, or, alternatively, may transmit a command signal to a remote server with or without the evaluation feedback as well. Still, alternatively, the JAVA applet may either execute the command locally within the applet code itself or may send the command signal to a remote server while buffering or maintaining locally the evaluation feedback data which may then be transmitted to a remote database or server at a later time.

In such an implementation, the JAVA code applet will execute locally on the computer system in conjunction with a client browser and transmit back to a remote server symbolic language which the server can use to interpret as indications of which regions within the evaluation component were selected.

Referring to FIG. 11, a flow chart of the process steps performed by evaluation module 230 and UI module 240 in accordance with the present invention is illustrated. Initially, the application, applet or webserver which controls the process, depending on the implementation of the invention, instructs UI module 240 to render the evaluation component appropriate to the current location in the process or page design, as illustrated by procedural step 1100. If, the evaluation component does not allow for selection of the command option without selection of an evaluation icon, UI module 240 waits for selection of one of the evaluation icons, as illustrated by decisional step 1102. Upon selection one of the evaluation icons by a user, UI module 240 initiates execution of the command or commands associated with the displayed command option, as illustrated by procedural step 1104. Such initiations may entail notifying application 220 which then executes the appropriate code. In the web server and applet embodiments this function may be performed directly by the web server or applet, respectively. Thereafter, evaluation module 230 registers the evaluation feedback data depending on which of the plurality of evaluation cons was selected by the user, as illustrated in procedural step 1106. As described previously, the process of registration of the evaluation feedback data may be performed with counters or updating of records and may be either done locally or the evaluation feedback data buffered and/or transmitted to a remote system. In addition, this function of evaluation module 230 may be performed by a web server or applet, as described previously. Thereafter, the evaluation component may be hidden, deleted or minimized from the graphic user interface display by UI module 240, as illustrated by procedural step 1108. If the application or process has been terminated, the process will end, as illustrated by decisional step 1110. Otherwise, evaluation module 230 will remain idle once the evaluation feedback data from the last selection has been recorded until UI module 240 renders another evaluation component. The procedural flow of the above flow chart will be modified slightly for embodiments of the invention in which users may select the command option without providing any evaluation feedback selection. In such case, step 1102 would determine if the command option was selected, and, procedural step 1106 may be eliminated.

Although the illustrative embodiments of the invention have been described with reference to a pointing device such as a mouse, it will be obvious to those reasonably skilled in the arts that other selection technique and apparatus can be used to select the command options, evaluation components or any subregions thereof. For example, one or more keystrokes, in series or in combinations, may be used to select any of the evaluation icons or the command option of the evaluation component. Alternatively, other pointing devices such as a touch sensitive screen overlay or a light pen or stylus may be used as a selection mechanism. Additionally, the present invention may be used with equal success in voice recognition systems to select the areas of the evaluation components. Other future technologies may likewise be equally adapted to use with the invention in light of the disclosure set forth herein.

In addition, although the above-described embodiments utilize multiple m feedback options, the present invention may be implemented with an evaluation component which includes a displayed command option and only a single evaluation icon. The usefulness of such single option data being determined by principles which are beyond the scope of this invention.

A software implementation of the above-described embodiments may comprise a series of computer instructions either fixed on a tangible medium, such as a computer readable media, e.g. diskette 142, CD-ROM 147, ROM 115, or fixed disk 152 of FIG. 1A, or transmittable to a computer system, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. Further, many of the system components described herein have been described using products from Lotus Development Corporation. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. Such modifications to the inventive concept are intended to be covered by the appended claims.

What is claimed is:

1. In a computer system having a display and capable of generating a user interface through which a user may interact with the system, a method for collecting user evaluation feedback comprising:
(A) displaying on the graphic user interface an evaluation component comprising at least one displayed command option and a plurality of evaluation feedback options;
(B) receiving user selection criteria for one of the command option and evaluation feedback options; and
(C) initiating execution of a command associated with the displayed command option.

2. The method of claim 1 further comprising:
(D) recording user selection of one of the plurality of evaluation feedback option.

3. The method of claim 2 wherein (D) further comprises:
(D1) initiating modification of counter value associated with the selected evaluation feedback option.

4. The method of claim 2 wherein (D) further comprises:
(D1) initiating modification of a record value associated with the selected evaluation feedback option.

5. The method of claim 4 wherein (D) further comprises:
(D2) transmitting the modified record value associated with the selected evaluation feedback option to a database.

6. The method of claim 1 further comprising:
(D) initiating execution of a command associated with one of the plurality of the displayed evaluation feedback options.

7. The method of claim 1 further wherein (A) comprises:
(A1) rendering the evaluation component with a separate user selectable subregion for the displayed command option and a separate user selectable subregion for the plurality of evaluation feedback options.

8. The method of claim 1 further wherein the plurality of evaluation feedback options are rendered as icons.

9. The method of claim 1 further wherein the evaluation component is rendered as part of an application user interface.

10. The method of claim 1 further wherein the evaluation component is rendered as part of a web page.

11. The method of claim 1 further wherein the evaluation component is rendered as part of a browser application.

12. A computer program product for use with a computer system having a display and capable of generating a user interface through which a user may interact with the system, the computer program product comprising a computer useable medium having embodied therein program code comprising:
(A) program code for displaying on the graphic user interface an evaluation component comprising at least one displayed command option and a plurality of evaluation feedback options;
(B) program code for receiving user selection criteria for one of the command option and evaluation feedback options; and
(C) program code for initiating execution of a command associated with the displayed command option.

13. The computer program product of claim 12 further comprising:
(D) program code for recording user selection of one of the plurality of evaluation feedback option.

14. The computer program product of claim 13 wherein (D) further comprises:
(D1) program code for initiating modification of counter value associated with the selected evaluation feedback option.

15. The computer program product of claim 13 wherein (D) further comprises:
(D1) program code for initiating modification of a record value associated with the selected evaluation feedback option.

16. A computer data signal embodied in a carrier wave for use with a computer system having a display and capable of generating a user interface through which a user may interact with the system, the computer data signal comprising:
(A) program code for displaying on the graphic user interface an evaluation component comprising at least one displayed command option and a plurality of evaluation feedback options;
(B) program code for receiving user selection criteria for one of the command option and evaluation feedback options; and
(C) program code for initiating execution of a command associated with the displayed command option.

17. An apparatus for use with a computer system having a display and capable of generating a user interface through which a user may interact with the system, the apparatus comprising:
(A) program logic for displaying on the graphic user interface an evaluation component comprising at least one displayed command option and a plurality of evaluation feedback options;
(B) program logic for receiving user selection criteria for one of the command option and evaluation feedback options; and
(C) program logic for initiating execution of a command associated with the displayed command option.

18. The apparatus of claim 17 further comprising:
(D) program logic for recording user selection of one of the plurality of evaluation feedback option.

19. The apparatus of claim 18 wherein (D) further comprises:
(D1) program logic for initiating modification of counter value associated with the selected evaluation feedback option.

20. The apparatus of claim 18 wherein (D) further comprises:
(D1) program logic for initiating modification of a record value associated with the selected evaluation feedback option.

21. The apparatus of claim 20 wherein (D) further comprises:
(D2) program logic for transmitting the modified record value associated with the selected evaluation feedback option to a database.

22. The apparatus of claim 17 further comprising:
(D) program logic for initiating execution of a command associated with one of the plurality of the displayed evaluation feedback options.

23. The apparatus of claim 17 further wherein (A) comprises:
(A1) program logic for rendering the evaluation component with a separate user selectable subregion for the displayed command option and a separate user selectable subregion for the plurality of evaluation feedback options.

24. An apparatus for use with a computer system having a display and capable of generating a user interface through which a user may interact with the system, the apparatus comprising:
(A) means for displaying on the graphic user interface an evaluation component comprising at least one displayed command option and a plurality of evaluation feedback options;
(B) means for receiving user selection criteria for one of the command option and evaluation feedback options; and
(C) means for initiating execution of a command associated with the displayed command option.

25. The apparatus of claim 24 further comprising:
(D) means for recording user selection of one of the plurality of evaluation feedback option.

26. In a computer system having a display and capable of generating a user interface through which a user may interact with the system, a method for collecting user evaluation feedback comprising:
(A) displaying on the graphic user interface an evaluation component comprising at least one displayed command option and at least one evaluation feedback option;
(B) receiving user selection criteria for one of the command option and the evaluation feedback option; and
(C) initiating execution of a command associated with the displayed command option.

27. The method of claim 26 further comprising:
(D) recording user selection of the at least one evaluation feedback option.
